(19) United States
(12) Patent Application Publication
(10) Pub. No.: US 2014/0219156 A1
(43) Pub. Date: Aug. 7, 2014

(54) OPTIMIZING WIRELESS LOCAL AREA NETWORK COMMUNICATIONS

(71) Applicant: THOMSON LICENSING, Issy de Moulineaux (FR)

(72) Inventors: David John Weaver, Fishers, IN (US); Martin Vincent Davey, Indianapolis, IN (US); Chaminda Jayamanne, Fishers, IN (US); Gregory William Cook, San Jose, CA (US)

(73) Assignee: THOMSON LICENSING, Issy de Moulineaux (FR)

(21) Appl. No.: 13/693,305

(22) Filed: Feb. 1, 2013

(51) Int. Cl. H04W 72/00

(52) U.S. Cl. CPC H04W 72/005
USPC 370/312

(57) ABSTRACT

A method and apparatus for optimizing wireless local area network communications are described including receiving a request, from a wireless device, to join a multicast group in order to receive multicast data, determining if the request is a request from a subsequent wireless device for the same multicast data, converting the multicast data to unicast data, if the request is not from a subsequent wireless device or the request is not for the same multicast data and transmitting the converted data to the wireless device that requested the multicast data.

### FIELD OF THE INVENTION

The present invention provides a method and apparatus for communicating multicast data over a wireless interface that does not simply broadcast all of the data all of the time.

### BACKGROUND OF THE INVENTION

In multicast and broadcast applications, data are transmitted from a server to multiple receivers over wired and/or wireless networks. A multicast system as used herein is a system in which a server transmits the same data to multiple receivers simultaneously, where the receivers form a subset of all the receivers up to and including all of the receivers. A broadcast system is a system in which a server transmits the same data to all of the receivers simultaneously. That is, a multicast system by definition can include a broadcast system.

Current gateway and router devices broadcast any and all multicast data received by the device over any wireless connections that exists on the device. Even if none of the devices using the wireless interface requested the multicast data, the router/gateway still broadcasts the multicast data, “just in case”. This practice “crowds” the interfaces with potentially unneeded traffic. As used herein data includes any form of content including audio, video and multimedia data of any form. As used herein, wireless devices associated with a gateway/router may include computers, laptops, dual mode smart phones, iPhones, iPads, iPods, tablets, wireless set top boxes, smart TVs or any other mobile device.

Multicast data has provisions within it that can be used to determine whether or not an associated device actually “wants” or “needs” the data. Devices subscribe to the data streams by sending an Internet Group Management Protocol “join” message to the source of that data. An IGMP “join” message is actually a message requesting to join a multicast group in order to receive multicast data (content). If a device on the wired LAN of a router “joins” a multicast group, that router will send that same data (content) out over the wireless interface even if no devices attached via the wireless interface did a “join” of their own. Conventionally, this was done as a simple solution to mitigate problems that might arise with multiple wireless devices that MIGHT request the traffic. The conventional mechanism was from a time when gateways and routers did not have enough performance or bandwidth to do anything more complex to solve the multicast traffic problem. Typically a router connects like and unlike networks such as WANs, MANs, LANs etc. That is, typically, a router is an interface between networks. Typically, a gateway provides an entry or exit into/out of a communications network. The terms router and gateway are used interchangeably herein. A home gateway is simply a gateway device that is used in a home/residential environment. A home gateway as used herein includes the functionality of both a router and a gateway and is used to connect the home network to networks outside the home such as the Internet or cable service provider or satellite provider or other networks provided by a communications provider.

### SUMMARY OF THE INVENTION

More recently routers and gateway devices have more processing power and bandwidth available and the present invention harnesses that available processing power and bandwidth to solve the problem of needlessly “flooding” the wireless medium with data that was not requested and is not wanted or needed.

A method and apparatus for optimizing wireless local area network communications are described including receiving a request, from a wireless device, to join a multicast group in order to receive multicast data, determining if the request is a request from a subsequent wireless device for the same multicast data, converting the multicast data to unicast data, if the request is not from a subsequent wireless device or the request is not for the same multicast data and transmitting the converted data to the wireless device that requested the multicast data.

### BRIEF DESCRIPTION OF THE DRAWINGS

The present invention is best understood from the following detailed description when read in conjunction with the accompanying drawings. The drawings include the following figures briefly described below:

FIG. 1A is a system level diagram of how routers/gateways presently handle multicast data (content).

FIG. 1B is a system level diagram of an exemplary home gateway of the present invention and how such a home gateway handles multicast data (content).

FIG. 2 is a block diagram of an exemplary home gateway in accordance with the principles of the present invention.

FIG. 3 is a flowchart of an exemplary implementation of a home gateway in accordance with the principles of the present invention.

### DETAILED DESCRIPTION OF THE PREFERRED EMBODIMENTS

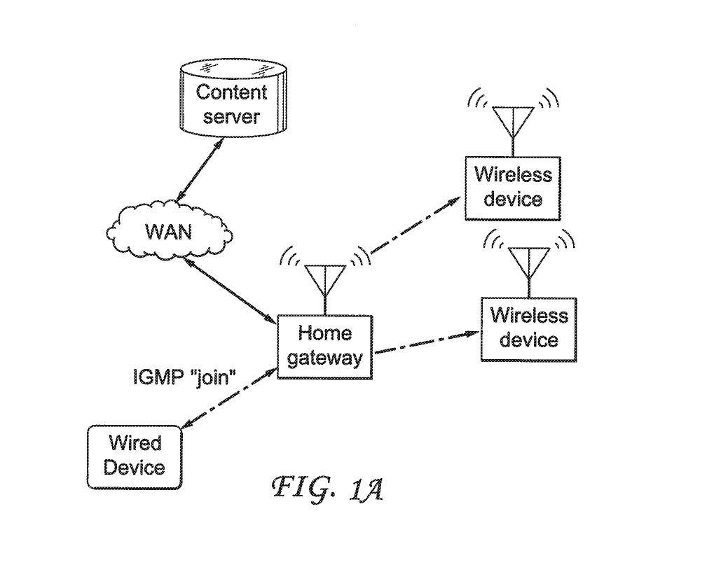

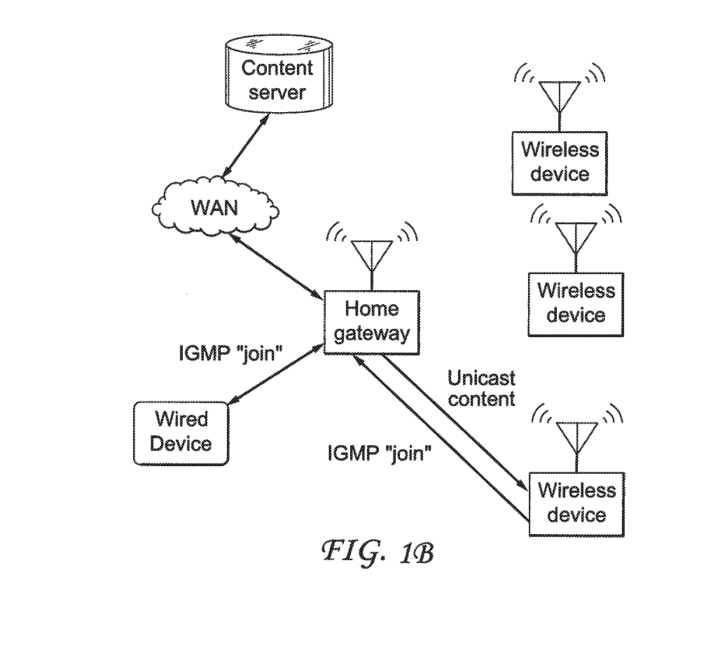

FIG. 1A shows a conventional nominal setup for a gateway/router delivering video from an internet location (WAN side). In the nominal case, once a wired LAN connected device asked for the content (data) via an IGMP join request, the gateway services this request by creating a multicast connection and providing this to the requesting device. The router/gateway device also sends this multicast data (content) out over the wireless network to any associated wireless devices because valid notifications may not be communicated between the wireless devices and the router/gateway due to potential traffic issues. Multicast connections are shown on FIG. 1A with lightning bolts.

Home gateways (routers and/or gateway devices) have the ability to distribute data (content) both in unicast and multicast. The present invention has no proxy but rather harnesses the increased processing power and bandwidth of more recent home gateways to effectively filter the data and more narrowly target users. Multicast-to-unicast conversion is used in the present invention in order to suppress flooding of the wireless interfaces. Another reason to use unicast in lieu of multicast is that unicast protocols typically have better error recovery because unicast protocols have the ability to acknowledge data (content) receipt and provide FEC and/or ARQ and other recovery techniques. Yet another reason to use unicast distribution is that not all users of the home network should be able to receive certain data (content). Some content may be undesirable to permit its viewing/rendering to minors due to violence or strong language.

Communication devices, specifically routers and gateway devices, now have both the performance (processing power) and bandwidth to be able to better provide the devices on both the wired and wireless interfaces with the proper (requested) multicast data. The router/gateway device can now watch for any IGMP “join” messages from wireless devices and, if the message is detected, create a proper and targeted connection to that wireless device to distribute the requested data (content). The multicast traffic can be converted to unicast traffic for transmission to the specific device rather than simply broadcasting/multicasting the data to all devices that happen to be available via the wireless interface. FIG. 1B is a system level diagram of an exemplary embodiment of the present invention. In the arrangement of the present invention the wireless devices join and receive the requested content in unicast. If a subsequent wireless device joins in order to receive the same content then the content is multicast to the requesting devices in order to conserve bandwidth. That is, the traffic (content, data) currently shown with a straight line between the home gateway and the wireless devices would become lightning bolts if more than one wireless device joined the multicast group to receive the same content (data).

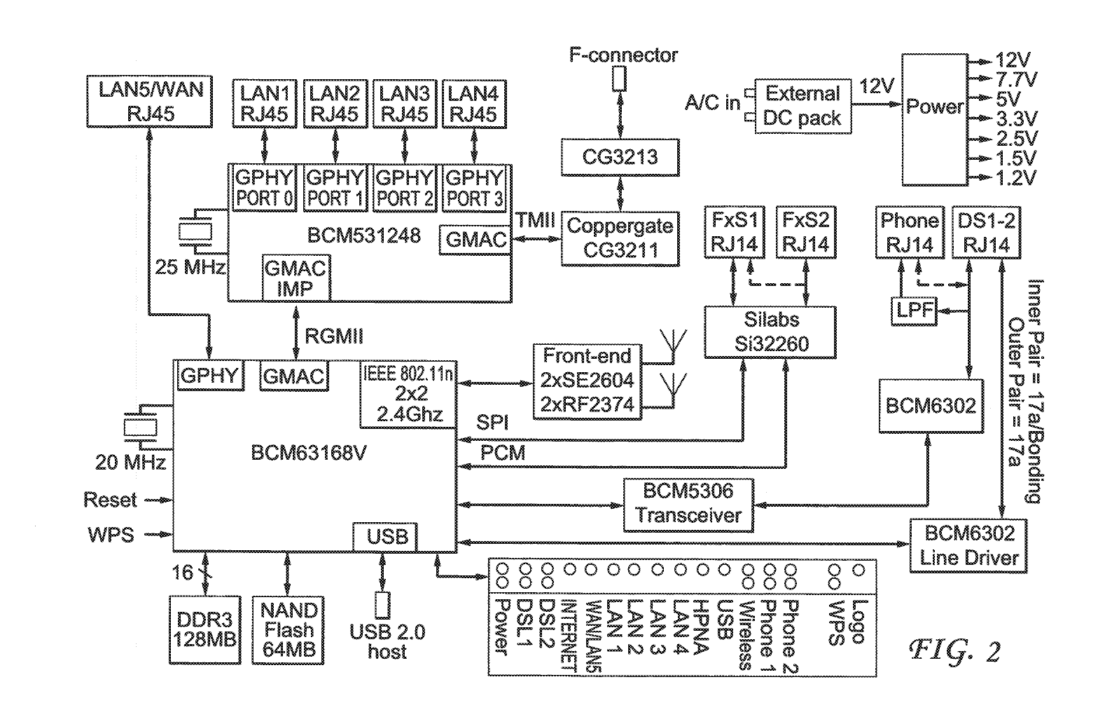

FIG. 2 is a block diagram of an exemplary home gateway in accordance with the principles of the present invention. The main control for the invention is found in the BCM63168V device (controller). That is, the present invention may be implemented as a program executable on processor/controller BCM63168V. An alternative implementation may be implementation on an application specific integrated circuit (ASIC) or on a field programmable gate array (FPGA) or an equivalent device. The wired interface goes through a BCM53124S device while the wireless communication operates through the Front-End block (multiple transceivers and antennas).

In FIG. 2, the means for receiving a request, from a wireless device, to join a multicast group in order to receive multicast data; would be performed by the front-end. The means for determining if the request is a request from a subsequent wireless device for the same multicast data would be the controller/processor (BCM63168V) which may include software (one or more executable programs) residing on the controller/processor. The means for converting the multicast data to unicast data, if the request is not from a subsequent wireless device or the request is not for the same multicast data would be the controller/processor (BCM63168V) which may include software (one or more executable programs) residing on the controller/processor. The means for transmitting the converted data to the wireless device that requested the multicast data would be performed by the front-end. The means for multicasting the multicast data if request is from a subsequent wireless device and the request is for the same multicast data would be performed by the front-end.

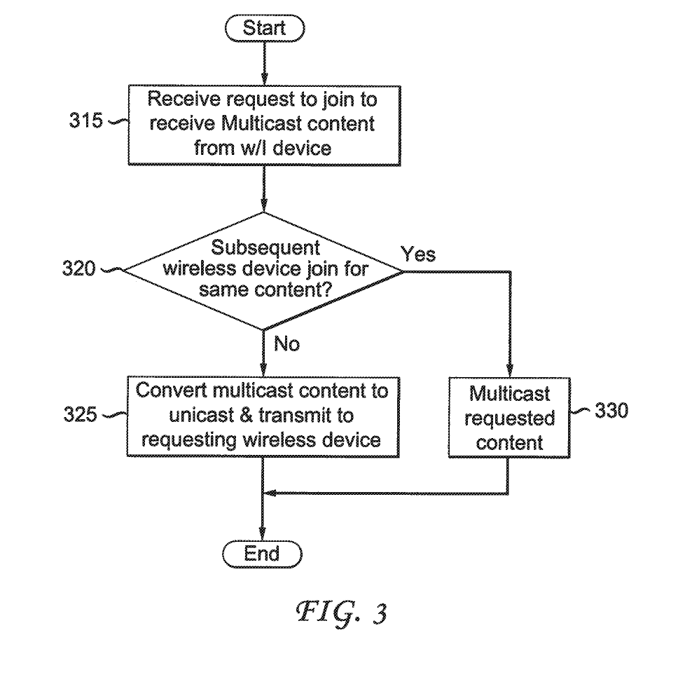

FIG. 3 is a flowchart of an exemplary implementation of a router/gateway device in accordance with the principles of the present invention. Not shown is the communication with the server in order for the home gateway device to request and receive content from the server (source of the content). At 315 the home gateway receives a request to receive multicast content from a wireless device associated with the home gateway. At 320 a test is performed to determine if the request to join by the wireless device to receive multicast content is a subsequent request to join to receive the same content as is being received by a previously joined wireless device. If the request to join by the wireless device to receive multicast content is not a subsequent request to join to receive the same content as is being received by a previously joined wireless device then the multicast content is converted to unicast and is transmitted to the requesting wireless device. If the request to join by the wireless device to receive multicast content is a subsequent request to join to receive the same content as is being received by a previously joined wireless device then the multicast content is multicast to all requesters of the same content. Not shown and independent of the process for wireless connections, the home gateway may receive a request to join a multicast group in order to receive multicast content from a wired device. The home gateway multicasts the requested content to the requesting wired device(s).

It is to be understood that the present invention may be implemented in various forms of hardware, software, firmware, special purpose processors, or a combination thereof Special purpose processors may include application specific integrated circuits (ASICs), reduced instruction set computers (RISCs) and/or field programmable gate arrays (FPGAs). Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed Given the teachings herein, one of ordinary skill in the related art will be able to contemplate these and similar implementations or configurations of the present invention.

1. A method for optimizing wireless local area network communications, said method comprising:
receiving a request, from a wireless device, to join a multicast group in order to receive multicast data;
determining if said request is a request from a subsequent wireless device for the same multicast data;
converting said multicast data to unicast data, if said request is not from a subsequent wireless device or said request is not for the same multicast data; and
transmitting said converted data to said wireless device that requested said multicast data.

2. The method according to claim 1, further comprising multicasting said multicast data if request is from a subsequent wireless device and said request is for the same multicast data.

3. An apparatus for optimizing wireless local area network communications, comprising:
means for receiving a request, from a wireless device, to join a multicast group in order to receive multicast data;
means for determining if said request is a request from a subsequent wireless device for the same multicast data;
means for converting said multicast data to unicast data, if said request is not from a subsequent wireless device or said request is not for the same multicast data; and
means for transmitting said converted data to said wireless device that requested said multicast data.

4. The apparatus according to claim 3, further comprising means for multicasting said multicast data if request is from a subsequent wireless device and said request is for the same multicast data.

5. The apparatus according to claim 3, wherein said apparatus is a home gateway.
